(19) United States
(12) Patent Application Publication
(10) Pub. No.: US 2003/0167177 A1
(43) Pub. Date: Sep. 4, 2003

(54) Transaction derived charitable contribution system

(76) Inventor: Donald Branch, Mechanicsville, VA (US)

Correspondence Address: BURNS DOANE SWECKER & MATHIS L L P, POST OFFICE BOX 1404, ALEXANDRIA, VA, 22313-1404, US

(21) Appl. No.: 09/817,163

(22) Filed: Mar. 27, 2001

(51) Int. Cl. G06F 17/60

(52) U.S. Cl. 705/1

(57) ABSTRACT

A transaction derived charitable contribution method. The method includes the steps of (1) enrolling at least one member; (2) receiving a designation of at least one charitable organization from the at least one member, the member being unrestricted as to which charitable organization is designated. The method also includes crediting a portion of the proceeds from a financial transaction to said designated charitable organization.

### BACKGROUND OF THE INVENTION

1. Field of the Invention

The present invention involves transaction processing capable of tracking individual transactions at the consumer level to provide incentive based merchant loyalty programs.

2. Brief Description of Related Art

It has been recognized that religious (e.g., Christian, Jewish, Muslim, etc.) communities and other types of communities have enormous purchasing power. Significant advantages would result if one were able to harness some portion of the purchasing power among a given community, direct the purchasing power of the community and target market to that community, to individual retailers.

The present invention provides ways of being able to track individual purchases at the retail level for incentive based programs which both cause retailers to want to draw the loyalty base of customers from a given community and give back to the community through charities that are important to their customers, as well as provide reasons for customers to be loyal to the merchants.

Specific retailers have provided programs which are applicable towards their specific business, but the programs do not cross over to different segments or to other retailers, per se. For instance, there is a large grocer in the Richmond marketplace called “Ukrops”, Ukrops has a program that it calls the “Golden Receipts” program wherein a customer's individual purchases are tracked. At the end of the month, the customer turns in his or her receipts or Ukrops track them manually. Either way, Ukrops donates a portion or small percentage of whatever the customer spent at Ukrops during that time period, back to the customer's church. The program is limited to purchases at Ukrops.

As another example, a gas station in the Richmond marketplace gives, for insurance, $0.02 per gallon of gasoline purchased back to the charity or non-profit organization of the customer's choice. So again, it is one specific retailer giving back to a customer's selected charity. Both Ukrops and the gas station now use membership cards with magnetic readable swipe strips to provide identifying information about the program, the customer and the charity.

Additionally, there are several online companies on the Internet that give back to charities, such as schoolcash.com, Christianshopper.com and a few others, that also take a percentage through an affiliate program and give back to a charity, based upon the customer's online purchases at that website, or by linking through their website.

### SUMMARY OF THE PRESENT INVENTION

The present invention provides an incentive based loyalty program which is not limited to a particular retailer or charity, but instead can be used at any member retailer and any charitable organization, whether a member or not. Part of what makes the present invention unique is that it provides a tax incentive back to the retailer, which has not been done in the past. More specifically, the retailer gets all of, or at least a portion of the proceeds, credited as a charitable contribution deduction on the retailer's Federal, and possibly, state tax returns. The designated charity can be any charitable organization as defined by the IRS code 501(3)(c), as long as they fall within the parameters of the IRS code, as may be amended from time to time. It is possible that the the present invention be extended to organizations that are not entitled to treatment as charitable organizations under the IRS code, but the present invention is of most value if the contribution goes to a charity or other organization as defined under the IRS code.

The Card Format

The valued customer membership card can be of any tangible or virtual form. In one embodiment, it looks like a standard credit card, but without the customer's name on it. The card would simply have a membership number on the card. There is the opportunity to put a unique brand on the card. Where there is a large enough membership for a particular organization, such as, by way of example, a church with a large congregation that uses the membership card, the card could be branded such that the front of the card bears indicia identifying the church and the program, together with a photo or an image of their church on the card and a member number across the bottom.

Also, it is a magnetic stripe card and the input is using standard credit card readers. Those readers would be updated or programmed to read the specific format that is on the card for the present invention. The information contained in the magnetic strip could be in the format of a standard credit card if reprogramming card readers is not preferred, but it does not need to be since there is no need for all the security. Just the membership number is required.

The Terminals

The terminals through which the membership cards can be swiped can be proprietary. However, instead of having a proprietary or unique terminal, a dual use terminal can be employed, i.e., an existing point-of-sale terminal which has been programmed to allow a function key to be entered when a membership card is to be used, and then the card swiped. The card can be used for processing credit card transaction, e.g., typical Visa or Mastercard transaction, but then it can also process the valued customer membership card.

While the dual use credit card terminal could use only the existing credit card network (which would require payment for the credit card processing service), it could also be that the valued customer information goes over a telephone line instead of going through the credit card network. By this dial around, instead of dialing into the card processor or the acquiring bank's processor, it would in turn dial into servers dedicated or partially dedicated to the implementing the present invention. Such dual function terminals can be provided at nearly no additional cost to the merchant over the cost of a standard terminal.

The Processes

The present invention can be broken down into six basic business subprocesses that all fit together. The first subprocess is member enrollment which is the way of registering new members into the program, members being individuals. The second subprocess is charity enrollment where churches or other charities are registered. The third subprocess is a merchant setup where local merchants agree to contribute a portion of the transaction amounts. A fourth subprocess is billing and accounting, which is the day-to-day operations of people purchasing merchandise or services, which are accounted for, the charities being paid and the affiliates and merchants being invoiced for their payments. A fifth subprocess is direct sales, which is the process used by providers of the present invention to directly market products and services either online, other the telephone or in person. The sixth subprocess involves affiliate programs which are agreements and arrangements which providers of the present invention make with companies such as Amazon.com, Barnes and Nobles, and any of the online companies where tags are passed and a percentage of any resulting transaction is given back to charities. The difference here is that providers of the present invention will pass most of the proceeds on to the charity member customer.

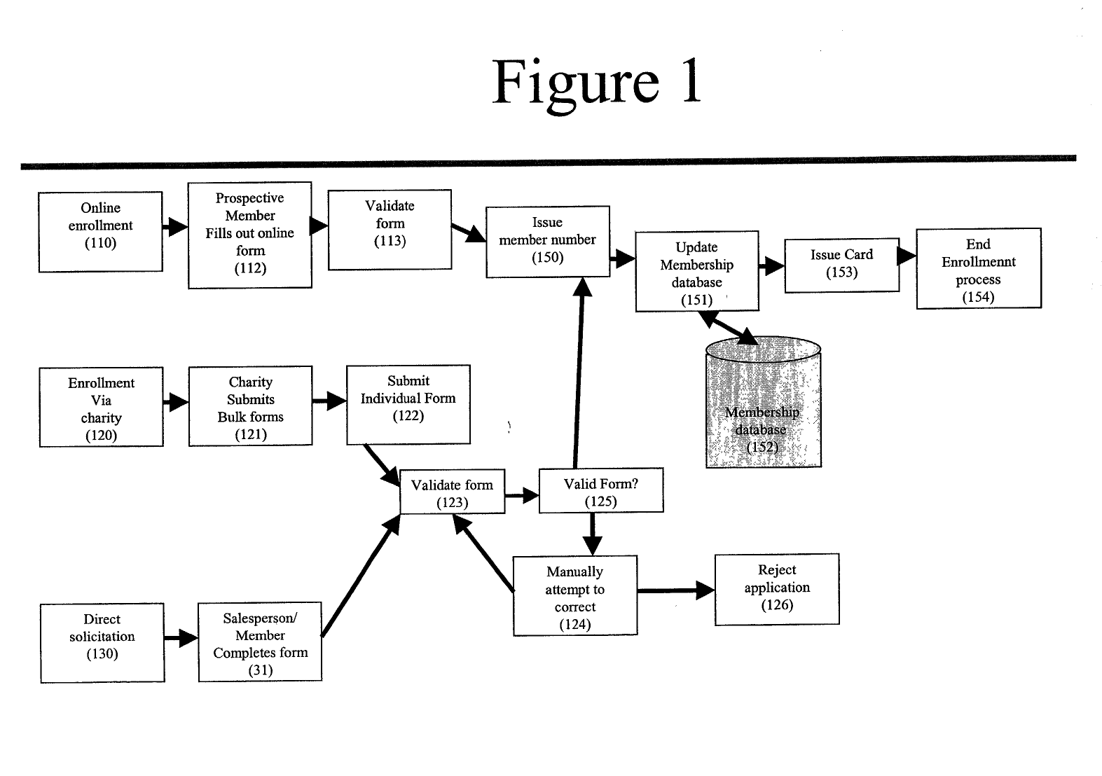

With specific reference to FIG. 1, the member enrollment (step 110), enrollment process involves online enrollment via a charity (step 120), and enrollment via direct solicitation by the providers of the present invention (step 130).

Online enrollment (step 110) involves prospective member registwring, using the Internet, the World Wide Web or other public or private network. A form is made available through the home page of the provider of the present invention, which is filled by the prospective member (step 112) by entering information such as the prospective member's name, address, telephone number, and one or more charities to which the prospective member would like the proceeds to go. If more than one charity is designated, the prospective member can allocate the percentage of the proceeds to go to those charities. When the member has completed the registration form, a submit button is hit, the (step 113) for validating the form information includes verifying the name, street, zip code, making sure they are valid, and checking to see if the charities are already in the database. If the charity is not in the database, the charity information goes into a pending charity database or register to be verified that it really is a valid charity.

The charity does not have to be enrolled before contributions can be processed. Instead, the member is allowed to start making purchases and crediting a portion of the transaction to a designated charity, but there will be no money sent to the charity until after the verification has been completed on the charity's status as a charity. If there is a failure for any reason, the individual will be informed that he or she has not designated a valid charity and will be given the opportunity to select an alternative, varifiable charity. The charity does not have to be a member of the network or otherwise enroll to receive the proceeds of transactions of a member designating the charity as the beneficiary, but their IRS status as a charity would have to be verified number by, for instance, writing the organization a letter asking for its tax identification number or other acceptable proof of status. This also provides an opportunity to make contact with the charity and to follow-up to identify more potential members and the like. There are also a number of error conditions which would be indicated, such as indicating when the prospective accurate, and the like. The online registration generally takes place with between the prospective member's computer and the server belonging to, run, hosted, or otherwise controlled by the provider of the present invention.

Once the form has been validated, a card number is issued to the new member (step 150). The member's membership number can be e-mailed to the new member or simply sent, embossed on a membership card.

As an alternative to online membership registration, charities can be used to facilitate enrollment (step 120) which have a number of members it would like to enroll which will have a physical form to distribute for individuals to fill out and turn back in. Where the form states “submit individual form”, which is after charities submit bulk forms (step 121) from processing each of the individual membership application in bulk form. Naturally, the paper form can be replaced by an interactive computer program or the like. For instance, each individual membership application form can be a sheet with a membership card with a pre-generated number affixed to it. The membership cards could then be used immediately (although the contributions would not be sent to the charity until other validation processing has been completed). The individual membership applications are submitted (122) either individually or in bulk, and thereafter validated (step 123). While one membership number could be shared, there is a perceived value to having different membership numbers for each individual member, such as tracking purchases, spending habits, etc., which might be of assistance, as providing better service to the charities and to the member merchants. For instance, by being able to track individual purchases to specific retailers, reports can be generated indicating which specific members have made purchases at specific retailers during the month, for instance. With this information, the charities can be contacted with information, perhaps down to the individual level where confidentiality is not a concern, to disclose the general level of participation, the percentage of dollars coming from specific retailers, etc. With this breakdown, participants will know how much they are supporting another specific mission or charity, or how much their members are supporting another cause or a sub-cause, etc. Every detail is valuable, and in a given instance, different mechanisms cam be employed to encourage the congregation or membership group to shop at popular sites and to the merchants to contribute more to the charity.

If the validation (step 122) results in error detection, then an attempt can be made to manually correct or correct through automation (e.g., handwriting recognition software) the errors (step 124). Once corrected, the application information is sent back through the validation process (step 123).

The third enrollment process (step 130) involves sales people of the provider of the present invention attending an association meeting of charities, and asking people to fill out an application form right there on site. Sales people could go to charitable organizations to try to obtain members throughout each organization. Retailers, for example, might agree to allow card readers in locally, and directly solicit potential members on site, either in person or through displays.

once the card number is issued or validated in instances where the card is attached to the enrollment form, the membership database is updated (step 151) in a physical database server (step 152), the physical card issued (step 153) if it has not already been provided, and the enrollment process ended (step 154).

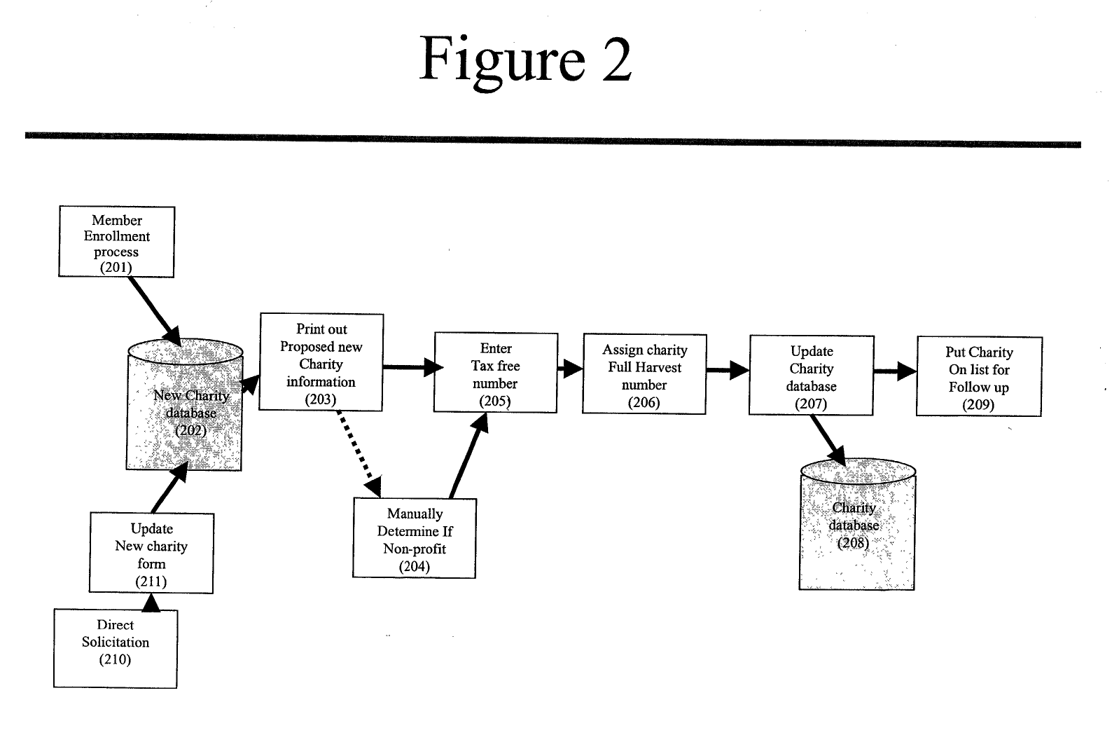

With reference to FIG. 2, the charity enrollment process will be described. There are two basic ways of a charity to be identified as part of the member enrollment process (step 210) or through direct solicitation (step 220) by the providers of the present invention.

When a new charity is identified during the enrollment process (step 210), information regarding the newly identified charity is entered into a new pending charity database (step 212). Also, if through direct solicitation a new charity is identified, a new charity form is updated (step 211) and the information regarding the new charity is entered into the new pending charity database (step 212). The new, pending charity database (step 212) is used during the normal validation process, but a printout or other output is provided (step 213). The status of the new, pending charity can be manually determined (step 214) and/or the tax exempt number entered into a database (step 215). The line between steps 213 and 214 is dashed to show a break in time where a person must contact the charity to find out whether it is a recognizable charity. The charity is then assigned a number by the provider of the present invention at step 216, and the charity database (step 218) is updated at step 217.

During this process, new charities can be asked to sign up additional members associated with that charity.

Among the advantages of the present invention is the amount of tax deduction for the charitable contribution. For instance, two-thirds of the charitable contribution is deductible by the retailer if the commission for the provider of the present invention is one-third. Another step can be implemented wherein the charity pays for administering the network. In this instance, under the US tax code, 100% of the contribution is tax deductible to the retailer because 100% of the contribution goes to the charity. The charity would pay the cost of, for instance, 25% for administering the fund. The lower percentage reflects the need for the charity to maintain some accounting records in the later situation.

For completeness, it is noted that the merchant transaction log is built when customers swipe the card. The card reader or point of sale terminal or the like logs the transaction into a regional center that is a server provided by a provider of the present invention. This server checks the membership status, sends back an authorization to the merchant and at the same time logs the time, who the merchant was, who the member was, and the transaction amount. Such a server would be linked to a database such as the SQL type database.

The exchange during a transaction with the server of the present invention enables checking whether an individual member can be authenticated and receive confirmation that their charitable contribution transaction has been registered. This also serves as an error detection mechanism wherein if members believe that they have made more transactions than are reflected in the transaction log, the discrepancy can be detected and the problem clarified or rectified.

It is also noted that the present invention can be embodied in something that looks very much like a credit card, functions as a credit card and branded as a credit card, but would actually be used only to debit a regular credit card. This would facilitate accounting to the member, since they would be receiving a credit card statement and that statement could include the amount and distribution of their charitable contributions.

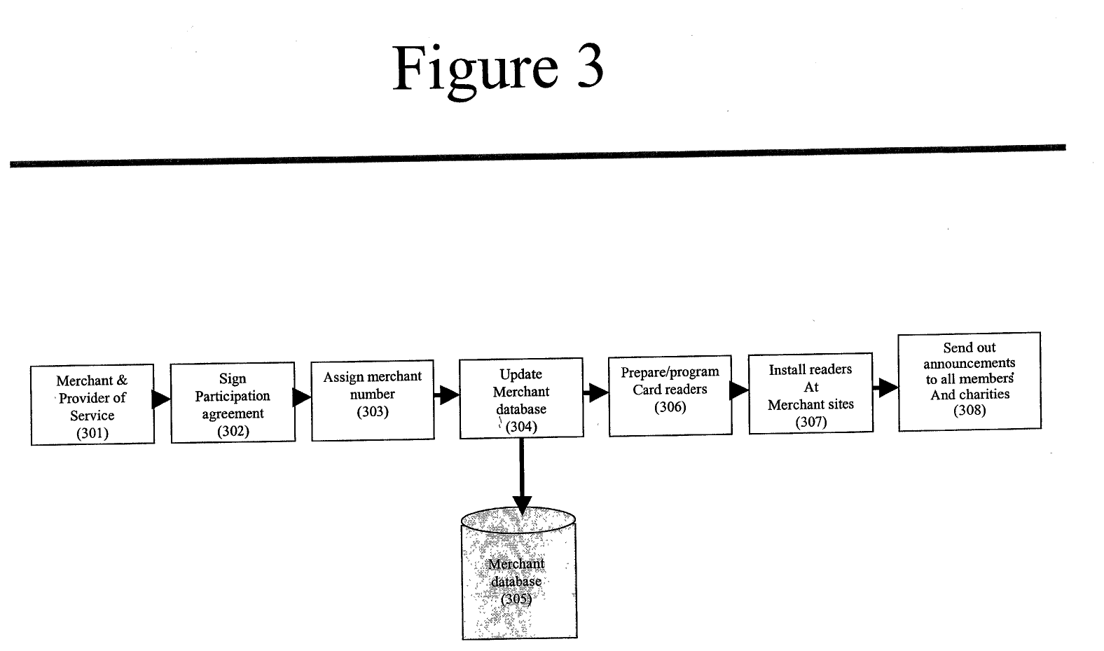

As shown in FIG. 3, the present invention also involves a merchant setup process. In this process, the merchant and the provider of the present invention meet to exchange data at step 301. The merchant can sign a participation agreement at step 302 and the merchant is assigned a member number at step 303. The participation agreement specifies such information as the merchant name, primary address, primary phone, primary fax, point of contact name, e-mail, billing address, billing phone, billing fax, billing point of contact name and for each site the point of contact name, the address, phone number, transaction phone number, ID, and fax number.

Once the merchant has been assigned a number at step 303, the database for merchants is updated at step 304. The merchant database is represented by such servers to the SQL server 305. Thereafter, at step 306, at the point of sale locations, the card reader is prepared or programmed to accept the valued customer membership cards. The reader are installed at the merchant sites at step 307 and announcements are thereafter sent to all members and their charities, as indicated at step 308.

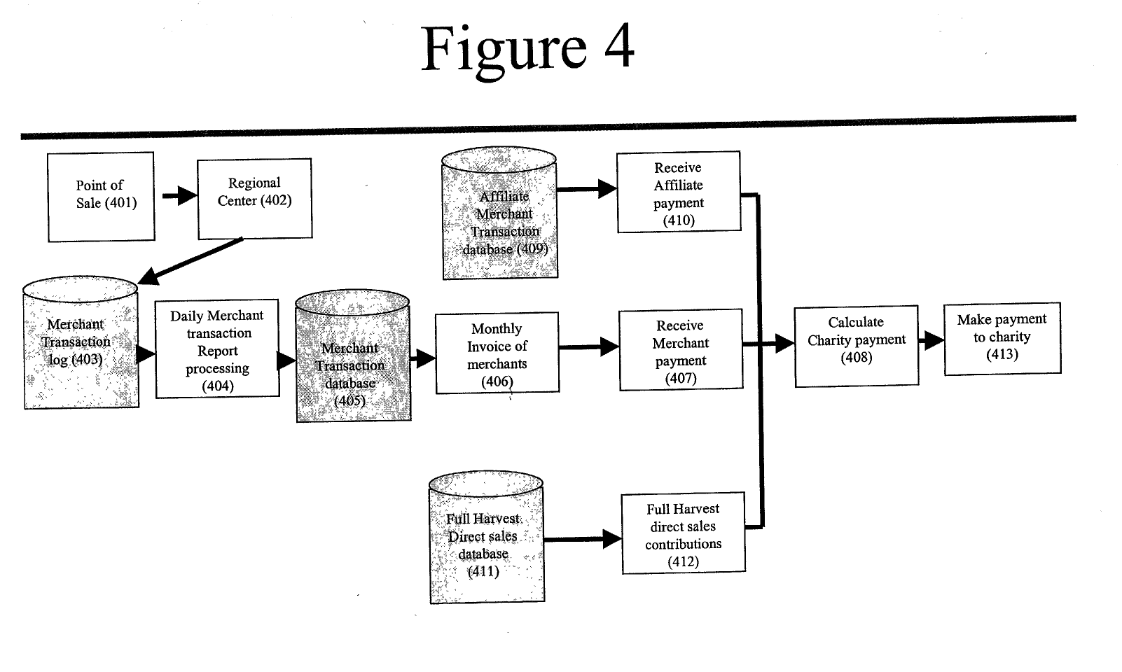

With reference to FIG. 4, the billing and accounting process is described. The point of sale sends transaction information at step 401 to the regional center of the providers of the present invention, as represented by step 402. The merchant transaction log is represented at step 403, which is continually updated by transactions, such as on a daily basis. The daily merchant transaction report is processed at step 404 and the merchant transaction database is updated at step 405. Thereafter, monthly invoices are sent to this merchant, as indicated at step 406. The providers of the present invention receives merchant payments, at step 407. Concurrent with this is affiliate merchant transaction databases 409 which receive affiliate payments as represented by 410. Additionally, the providers of the present invention update their direct sales database at step 411, and this direct sales contributions are processed at step 412. All of the received affiliate payment information, the received merchant payment information and the direct sales contributions are input to calculate the charity payment at step 408, after the charity has been validated. Thereafter, at step 409, the payment to the charity is effectuated. The merchant invoice includes a list of individual transactions by date, time and amount. The total amount due to the providers of the present invention is also indicated. The merchant then would have a prescribed period, such as 30 days, to pay the invoice. The charity payment is calculated and prepared within, for instance, 60 days, of invoicing. Perhaps there would be opportunities for additional information to be provided at a cost, such as membership data or purchasing trends of members.

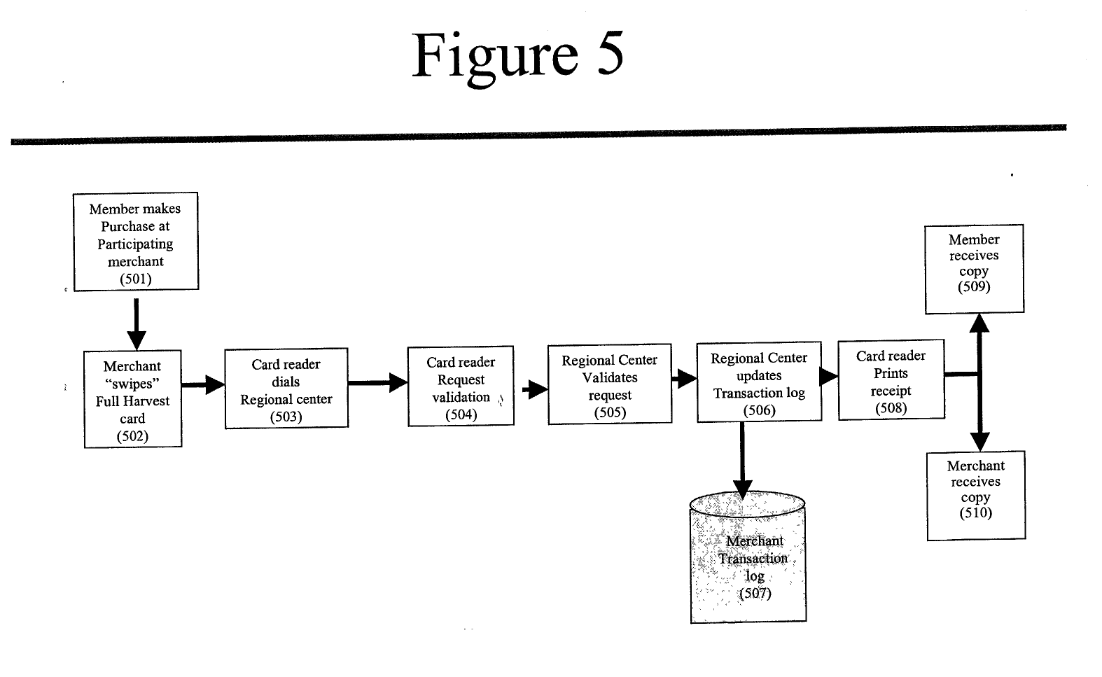

With reference to FIG. 5, the merchant sales process is described. At step 501, a member makes a purchase at a participating merchant. The merchant then swipe the valued customer card, or calls it in or keys it in, as appropriate to equipment at the merchant's site. See step 502. Thereafter, the card reader dials the regional center of the provider of the present invention, at step 503. The card reader requests validation at step 504 and the regional center either validates or does not validate the request at step 505. The regional center then updates the transaction log at step 506, the merchant transaction log being represented by the database 507. Thereafter, the card reader prints a receipt, at step 508 and the member receives a copy, as indicated at 510.

It should be noted that the card reader can be a standard transaction type device used for credit card transactions but be reprogrammed to provide the additional functionality needed for the present invention, to which the program transaction devices at the merchant site will automatically dial into this center to process the transactions. The regional center is responsible for validating the recording transactions. The request validation also provides the number of the merchant with account information for tracking purposes.

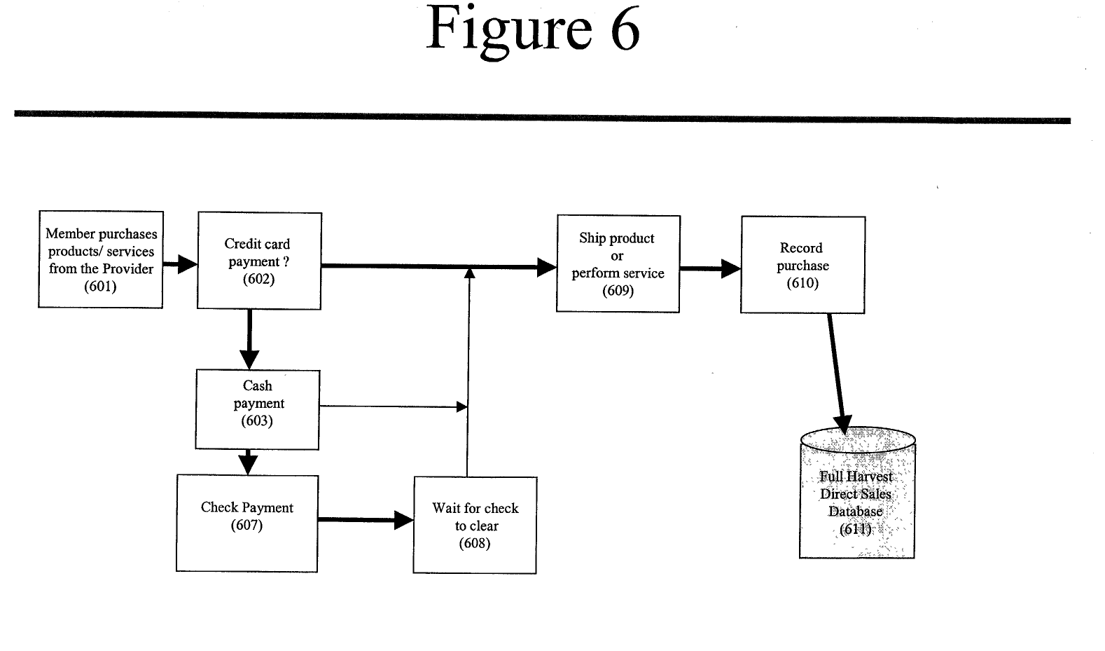

With reference to FIG. 6, the direct sales process is described. In this process, as shown at step 601, members purchase products and/or services from the providers of the present invention. If the payment is to be made by credit card, it is processed at step 602, and then the product is shipped or the service performed, at step 609. However, if it is not a credit card payment but is instead a cash payment, it is processed as such at step 603 and the product is shipped or delivered and/or the service performed. If it is neither a credit card payment or a cash payment, but instead is a check payment, the check is processed at step 607 check to clear, as indicated at step 608.

Concurrent or after the product in shipped or the service performed, the purchase is recorded at step 610 and, a portion of the proceeds, is credited to the charity as indicated in the provider of the present invention's database 611.

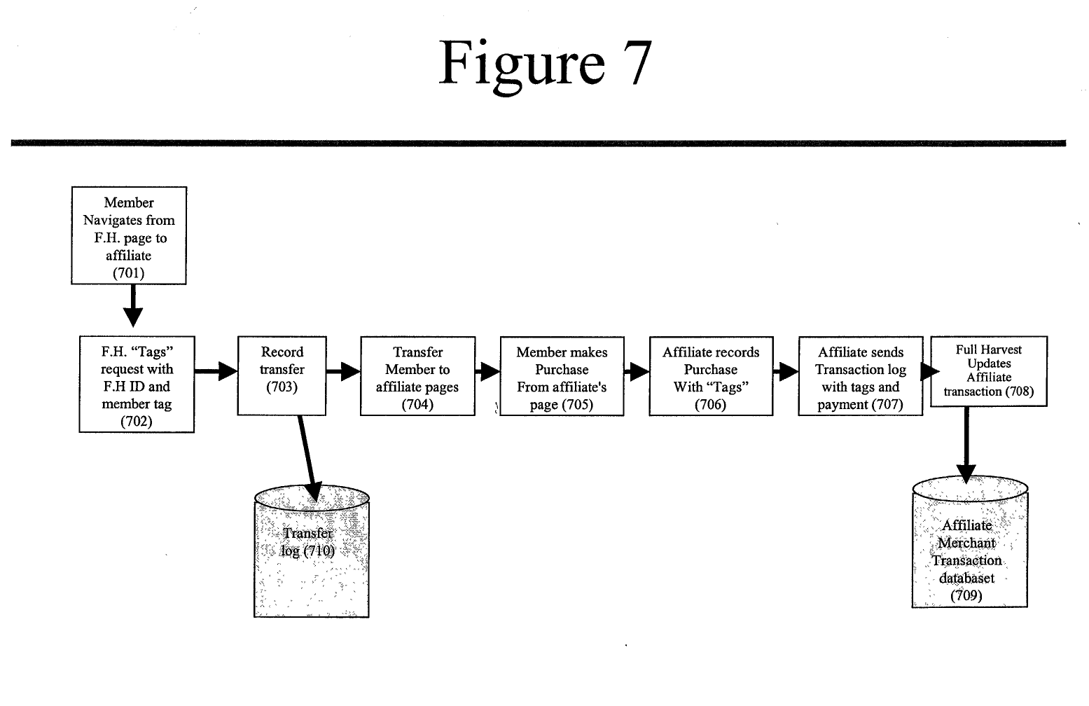

With respect to FIG. 7, affiliate program process is described. This process can be associated with such organizations as Amazon.com The member navigates online from the home page of the providers of the present invention, as shown at step 701. The home page tags the request with the valued customer membership number and identification. The record is then transferred as show in step 703, and a transfer log is updated as shown in step 710. The transferred member then arrives at the affiliated pages, as indicated at step 704 and the member makes a purchase from the affiliate pages, as indicated at step 705. The affiliate records the purchase with the “tag” indicating membership in this program, as shown in step 706. The affiliate then sends the transaction log with the tag and payment to the providers of the present invention, as shown at step 707 and the providers of the present inventions updates the affiliate transaction log, as shown at step 706 in the merchant transaction database 709.

It will be appreciated that information regarding the spending habits of members can be of great value to both the charities and the merchants. For instance, the spending habits may direct businesses to include longer hours on particularly heavy transaction days, the travel patterns of members, and the effectiveness of ad campaigns, and the like. This value added data provides membership profiles and the like.

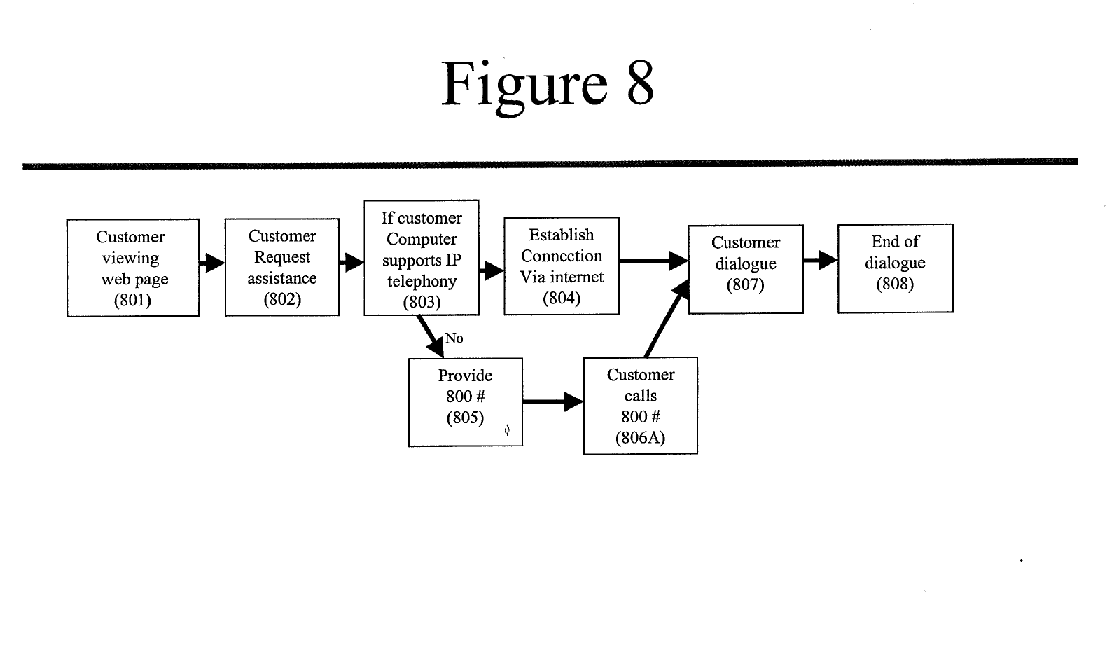

With reference to FIG. 8, the providers of the present invention can also provide online services. For instance, a customer can view the home page of the provider of the present invention, as indicated at step 801. The customer can request assistance, as indicated at step 802 and, if the customer's computer supports Internet protocol telephoning as determined at step 803, a connection would be established by the Internet as indicated at step 804. If the customer's computer does not support this IP telephoning, then he or she is provided with a toll free number of the providers of the present invention, as indicated at step 805. The customer is then free to call the providers of the present invention, as indicated at step 806. Either way, the customer and the providers of the present invention engage in a dialogue as indicated at step 807 which, hopefully, ends in a solution to the customer's problem, as indicated at step 808.

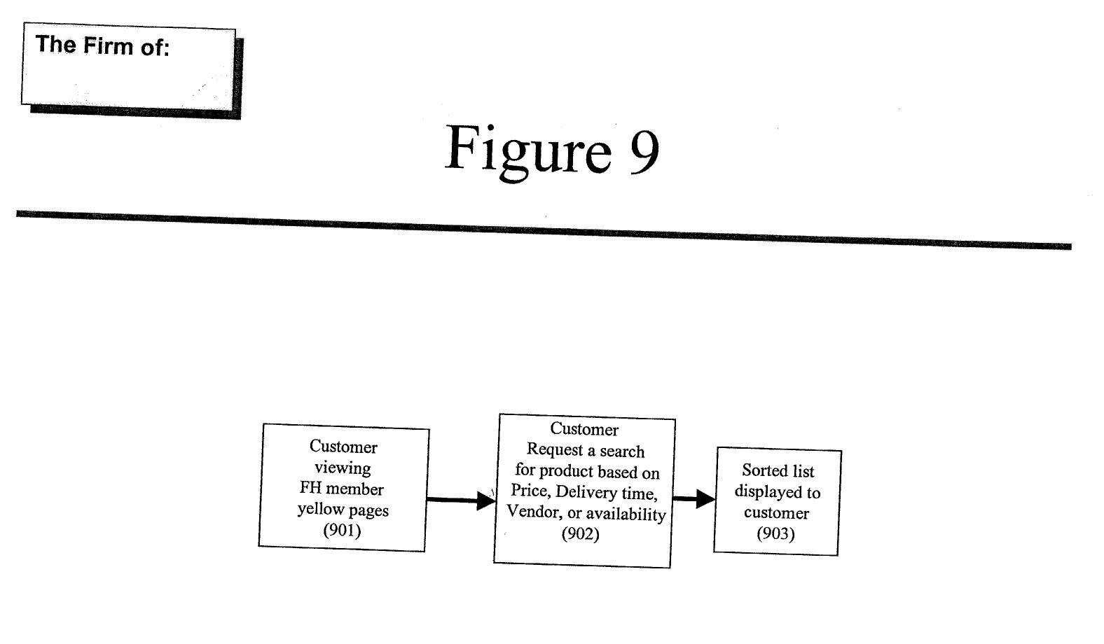

With reference to FIG. 9, the customer is provided with a merchant membership yellow pages, as indicated at step 901. The customer can request a search based on price, delivery, vendor, or availability, as indicated at step 902. Thereafter, this sort of list is displaye to the customer, as indicated at step 903 via the home page of the provider of the present invention.

The present invention has been described by way of example. Other modifications and variations will no doubt occur to those skilled in the art do not depart from the spirit and scope of the present invention.

What is claimed is:

1. A transaction derived charitable contribution method, comprising the steps of:
enrolling at least one member:
receiving a designation of at least one charitable organization from said at least one member, said member being unrestricted as to which charitable organization is designated; and
crediting a portion of the proceeds from a financial transaction to said designated charitable organization.

2. A method in accordance with claim 1, further comprising the steps of:
validating whether said designated charitable organization has charitable status according to at least one appropriate taxing authority; and
making payment to the designated charitable organization if its charitable status is validated.

3. A method in accordance with claim 2, further comprising the steps of:
when charitable status of the designated charitable organization cannot be validated:
(1) informing said enrolled member that the designated charitable organization is not a valid charity according to the at least one taxing authority when charitable status cannot be confirmed; and
(2) provide another opportunity to said at least one enrolled member to select another charity.

4. A method in accordance with claim 1, further comprising the step of issuing a member number to said enrolled member.

5. A method in accordance with claim 1, further comprising the step of:
soliciting for enrollment charitable organizations that have been identified by being designated by said at least one enrolled member.
